(19) United States
(12) Patent Application Publication
(10) Pub. No.: US 2024/0375228 A1
(43) Pub. Date: Nov. 14, 2024

(54) MACHINE TOOL AND METHOD FOR OPERATING THE MACHINE TOOL

(71) Applicant: Fill Gesellschaft m.b.H., Gurten (AT)

(72) Inventors: Friedrich DALLINGER, Gurten (AT); Markus GADRINGER, Gurten (AT)

(73) Assignee: Fill Gesellschaft m.b.H., Gurten (AT)

(21) Appl. No.: 18/285,958

(22) PCT Filed: Jul. 22, 2021
(86) PCT No.: PCT/EP2021/070568

§ 371 Date: Oct. 23, 2023

(30) Foreign Application Priority Data
Jul. 24, 2020 (EP) 20187633.1
Mar. 18, 2021 (EP) 21163345.8

(51) Int. Cl. B23Q 3/155

(52) U.S. Cl. CPC B23Q 3/15503

(57) ABSTRACT

A machine tool includes: a machine frame; at least a first working spindle which is pivoted about a first spindle axis; at least a second working spindle which is pivoted about a second spindle axis; a workpiece clamping device which is configured to receive at least a first workpiece and a second workpiece. The first working spindle and the second working spindle are arranged vertically one above the other.

The invention relates to a machine tool and a method for operating the machine tool, as well as a machining system comprising at least two machine tools.

Double-spindle machines are known from WO 2005/025801 A1 and WO 00/37213 A2. In such double-spindle machines, two workpieces can be machined simultaneously by means of a tool inserted in each of the tool spindles. Both tool spindles and thus both tools are moved synchronously in the three axes of the coordinate system so that identical machining operations are performed on both workpieces.

The double-spindle machines known from WO 2005/025801 A1 and WO 00/37213 A2 have the disadvantage that, due to their design, the maximum length of the workpiece that can be machined is limited.

The object of the present invention was to overcome the disadvantages of the prior art and to provide an improved machine tool, and an improved method of operating the machine tool, and an improved machining system.

This object is solved by an apparatus and a method according to the claims.

A machine tool is configured according to the invention. The machine tool comprises:
a machine frame;
at least a first working spindle which is pivoted around a first spindle axis;
at least a second working spindle which is pivoted around a second spindle axis;
a workpiece clamping device which is configured to receive at least a first workpiece and a second workpiece. The first working spindle and the second working spindle are arranged vertically one above the other.

The machine tool according to the invention provides the advantage that long workpieces can be machined simply with high efficiency.

Furthermore, it can be expedient for the first working spindle and the second working spindle to be arranged on a common spindle adjustment device and to be jointly displaceable along a Z-axis aligned parallel to the spindle axes. This provides the advantage that the first working spindle and the second working spindle can be moved by means of a joint drive. The construction of the machine tool can thereby be simplified.

Alternatively, it can be provided that the first working spindle is displaceable along the Z-axis by means of a first spindle adjustment device, and that the second working spindle is displaceable along the Z-axis by means of a second spindle adjustment device, wherein the first working spindle and the second working spindle can be moved independently of one another. This provides the advantage that the first working spindle and the second working spindle can perform machining operations independently of one another, so that two differently configured workpieces can be machined simultaneously in the machine tool.

Furthermore, it can be provided that the first working spindle and/or the second working spindle is/are arranged pivotably on the machine frame by means of a swivel bearing. The first spindle axis or the second spindle axis can thus be pivotable from the horizontal position into a position deviating at an angle thereto.

Furthermore, it can be provided that in addition to the first working spindle and to the second working spindle, a third working spindle is configured, wherein the first working spindle, the second working spindle and the third working spindle are arranged vertically one above the other. This provides the advantage that the efficiency of the machine tool can be further increased.

An embodiment according to which it can be provided that the workpiece clamping device comprises at least a first workpiece table and a second workpiece table, wherein the first workpiece table is pivoted about a first pivot axis which is aligned parallel to a horizontal X-axis, and the second workpiece table is pivoted about a second pivot axis which is aligned parallel to the X-axis, and that the first working spindle is assigned to the first workpiece table and the second working spindle is assigned to the second workpiece table, can also be advantageous. This provides the advantage that the workpiece(s) to be machined can be machined with high precision and good efficiency.

Furthermore, it can be provided that the workpiece clamping device comprises at least a first workpiece table and a second workpiece table, wherein the first workpiece table is pivoted about a first pivot axis which is aligned parallel to a horizontal X-axis, and the second workpiece table is pivoted about a second pivot axis which is aligned parallel to the X-axis, and in that the first working spindle is assigned to the first workpiece table and the second working spindle is assigned to the second workpiece table, and in that a fourth working spindle is configured which is assigned to the first workpiece table and in that a fifth working spindle is configured which is assigned to the second workpiece table, wherein the first working spindle and the fourth working spindle are arranged at a distance from one another in relation to the horizontal X-axis and wherein the second working spindle and the fifth working spindle are arranged at a distance to one another in relation to the horizontal X-axis. This increases the efficiency of the machine tool.

Furthermore, it can be provided that the workpiece clamping device comprises at least a first rear workpiece table and a second rear workpiece table, wherein the first rear workpiece table is pivoted about a first rear pivot axis which is aligned parallel to a horizontal X-axis, and the second rear workpiece table is pivoted about a second rear pivot axis which is aligned parallel to the X-axis, and in that the first workpiece table and the second workpiece table are arranged on a first side of a swivel bridge which is pivoted around a swivel bridge axis aligned parallel to the X-axis, and in that the first rear workpiece table and the second rear workpiece table are arranged on a second side of the swivel bridge, wherein depending on the swivel position of the swivel bridge the first working spindle and the fourth working spindle are assigned to the first workpiece table and the second working spindle and the fifth working spindle are assigned to the second workpiece table or
the first working spindle and the fourth working spindle are assigned to the first rear workpiece table and the second working spindle and the fifth working spindle are assigned to the second rear workpiece table. This increases the efficiency of the machine tool.

Furthermore, it can be provided that a fourth workpiece table and a fifth workpiece table are arranged on the machine frame, wherein the first workpiece table and the fourth workpiece table are arranged at a distance to one another in relation to the horizontal X-axis and wherein the second workpiece table and the fifth workpiece table are arranged at a distance to one another in relation to the horizontal X-axis, wherein the first working spindle is assigned to the first workpiece table and wherein the second working spindle is assigned to the second workpiece table and wherein the fourth working spindle is assigned to the fourth workpiece table and wherein the fifth working spindle is assigned to the fifth workpiece table. This increases the efficiency of the machine tool.

According to a further embodiment, it is possible that the workpiece clamping device comprises at least a first rear workpiece table and a second rear workpiece table, wherein the first rear workpiece table is pivoted about a first rear pivot axis which is aligned parallel to a horizontal X-axis, and the second rear workpiece table is pivoted about a second rear pivot axis which is aligned parallel to the X-axis, and in that the first workpiece table and the second workpiece table are arranged on a first side of a swivel bridge which is pivoted about a swivel bridge axis aligned parallel to the X-axis, and in that the first rear workpiece table and the second rear workpiece table are arranged on a second side of the swivel bridge, wherein depending on the swivel position of the swivel bridge the first working spindle is assigned to the first workpiece table and the second working spindle is assigned to the second workpiece table or the first working spindle is assigned to the first rear workpiece table and the second working spindle is assigned to the second rear workpiece table. This provides the advantage that workpieces clamped on the first workpiece table or on the second workpiece table can be machined whilst on the first rear workpiece table or on the second rear workpiece table the already machined workpieces can be removed and new workpiece blanks can be inserted. This can further increase the efficiency of the machine tool. Such an embodiment of the workpiece clamping device in conjunction with the first working spindle and second working spindle arranged exchangeability of the already machined workpieces.

In particular, it can be provided that for changing the workpieces the swivel bridge is positioned in such a swivel position that the first workpiece table and the second workpiece table are arranged next to one another at a horizontal distance. This provides the advantage that the workpieces can be changed easily. In particular, lifting devices such as chains or other traction devices can be used to change the workpieces, which can only absorb traction forces. In addition, this measure makes the workpiece tables accessible to a workpiece changing device which is arranged overhead. This can be a rail-guided workpiece changing device, for example.

Furthermore, it can be expedient for the swivel bridge axis to be arranged centrally between the first pivot axis, the second pivot axis, the first rear pivot axis, and the second rear pivot axis. This provides the advantage that the first workpiece table and the first rear workpiece table or the second workpiece table and the second rear workpiece table, when they are pivoted into the machining area of the machine tool, assume the same position and thus the machining of the workpieces can be carried out without any necessary compensation of the position of the working spindles or the swivel bridge.

Furthermore, it can be provided that a partition wall is configured between the first side of the swivel bridge and the second side of the swivel bridge, wherein in the machining state of the machine tool a working area of the machine tool is separated from an outer area of the machine tool by the partition wall. This provides the advantage that the working area of the machine tool can be closed off by the partition wall, so that the machine safety of the machine tool can be increased. Furthermore, this measure can reduce noise emission from the machine tool.

Furthermore, it can be provided that a distance between the first working spindle and the second working spindle is adjustable along a vertical Y-axis by means of a spindle distance compensation device. This provides the advantage that any thermal expansions of the machine tool can be balanced out so that the relative position of the first working spindle to the first workpiece table and of the second working spindle to the second workpiece table is the same during the entire machining operation of the machine tool.

According to a particular embodiment, it is possible that a tool magazine is arranged at a longitudinal end of the workpiece clamping device, wherein the tool magazine comprises a chain circulation magazine, wherein a straight run of the chain circulation magazine is arranged vertically, wherein the first working spindle and the second working spindle can be displaced to the straight run of the chain circulation magazine, wherein a distance between the first working spindle and the second working spindle corresponds to a pitch or a multiple of the pitch of the chain circulation magazine. It is thereby advantageous that the first working spindle and the second working spindle can be moved to the chain circulation magazine in order to deposit the no longer needed machining tool and receive a new machining tool. Due to the fact that the distance between the first working spindle and the second working spindle corresponds to a pitch or a multiple of a pitch of the chain circulation magazine, the machining tools received in the first working spindle and the second working spindle can be deposited simultaneously, or in a broader step new machining tools can be simultaneously received.

Furthermore, it can be provided that a further tool magazine is arranged at a second longitudinal end of the workpiece clamping device, wherein the further tool magazine is configured symmetrically to the tool magazine. This increases the efficiency of the machine tool.

As an alternative embodiment variation to the straight run of the chain circulation magazine in the region of the two working spindles, it can also be provided that between the two working spindles the chain circulation magazine has a guide which deviates from the straight run, such as having a curvature or an omega-shaped or trapezoid-shaped chain guide. Thus, a distance between the first working spindle and the second working spindle does not have to correspond to a pitch or a multiple of a pitch of the chain circulation magazine, but rather a different pitch can be selected. It can also be provided here that the pitch of the chain circulation magazine is selected such that the respective provision positions of the chain circulation magazine are arranged at a distance between the first working spindle and the second working spindle.

A method for operating a machine tool is provided for according to the invention. The machine tool comprises a machine frame, a first working spindle which is pivoted about a first spindle axis, at least a second working spindle which is pivoted about a second spindle axis, and a workpiece clamping device which is configured to receive at least a first workpiece and a second workpiece, wherein the first working spindle and the second working spindle are arranged vertically one above the other. The method comprises the following method steps:
machining the first workpiece by means of the first working spindle;
machining the second workpiece by means of the second working spindle.

The machining of the first workpiece and the machining of the second workpiece is performed simultaneously.

The method according to the invention provides the advantage that long workpieces can be machined simply with high efficiency.

In particular, it can be advantageous if a change of the machining tool clamped in the first working spindle and a change of the machining tool clamped in the second working spindle is performed simultaneously, wherein the machining tools are received in a chain circulation magazine with several machining tool receptacles, wherein those machining tools arranged in those machining tool receptacles which correspond to the distance between the first working spindle and the second working spindle are configured structurally identically, wherein in a first method step the machining tool clamped in the first working spindle and the machining tool clamped in the second working spindle are each deposited in a vacant machining tool receptacle of the chain circulation magazine and in a second method step the chain circulation magazine or the two working spindles are displaced so that the first working spindle and the second working spindle are aligned with the machining tools to be newly received and wherein in a third method step the machining tools to be newly received are received in the first working spindle and in the second working spindle. This measure can shorten set-up time, which can further increase the efficiency of the machine tool.

Furthermore, it can be provided that a fourth workpiece is received on the fourth workpiece table and that a fifth workpiece is received on the fifth workpiece table, wherein the fourth working spindle serves to machine the fourth workpiece and wherein the fifth working spindle serves to machine the fifth workpiece, wherein the machining of the first workpiece, the machining of the second workpiece, the machining of the fourth workpiece and the processing of the fifth workpiece take place simultaneously. This measure can further improve the efficiency of the machine tool, whilst at the same time keeping the complexity of the machine tool as low as possible.

Furthermore, it can be provided that the first workpiece, the second workpiece, the fourth workpiece and the fifth workpiece have the same configuration, wherein the machining on the first workpiece, on the second workpiece, on the fourth workpiece and on the fifth workpiece is performed in parallel in simultaneous method steps. This measure can further improve the efficiency of the machine tool, whilst at the same time keeping control of the machine tool simple as possible.

Furthermore, it can be provided that the first workpiece table, the second workpiece table and where necessary the third workpiece table are arranged offset to one another in the direction of the Z-axis. That can allow for the individual workpiece tables to be accessible from above, such that the machining tools can be lifted off the workpiece tables by means of a crane entering from above, for example. In addition, this measure can ensure that chippings from a machining tool of an upper working spindle cannot fall onto a machining tool of a lower working spindle where they could disrupt the machining operation.

Furthermore, it is conceivable that the first workpiece table, in particular the uppermost workpiece table, is arranged offset at the greatest distance to the working head in the Z-axis direction. The second workpiece table can be arranged at a greater distance from the working head in the Z-axis direction than the first workpiece table. The third workpiece table can be arranged at a greater distance from the working head in the Z-axis direction than the second workpiece table.

It is thereby conceivable that the individual working spindles are also arranged offset to one another in the Z-axis direction. In particular, it can be provided that the offset of the individual working spindles in the Z-axis direction is the same as the offset of the individual workpiece tables in the Z-axis direction. This can ensure that the individual working spindles can be arranged on a joint working head and by jointly displaced in the Z-axis direction by the joint working head.

According to a further embodiment, it is also conceivable that the individual working spindles are arranged one above the other in an aligned manner and that the individual workpiece tables are individually and independently displaceable along the Z-axis. Thus, during machining of the workpieces clamped on the workpiece tables, they can be arranged one above the other in an aligned manner. For workpiece changing, the individual workpiece tables can be arranged offset to one another along the Z-axis.

It is thereby further conceivable that the individual working spindles are not displaceable along the Z-axis.

Alternatively, it is also conceivable that the individual working spindles are displaceable along the Z-axis and that additionally the individual workpiece tables are displaceable along the Z-axis. That allows for the main displacement movement along the Z-axis to be performed by the working spindles and the displaceability of the individual workpiece tables along the Z-axis can be used for tolerance adjustment.

According to the invention, a machining system is configured which comprises at least two machine tools, wherein joint control technology and/or joint media supply is configured for both machine tools.

The machining system according to the invention provides the advantage that due to the joint use of the control technology and/or the joint media supply, the machining system can be kept simple and thus efficient and with low susceptibility to errors.

Moreover, it can be provided that the two machine tools are configured symmetrically to one another. This provides the advantage that the control technology or the joint media supply can be arranged centrally between the two machine tools, wherein the same cable length from the joint control technology and/or the joint media supply to the respective actuators or media outputs can be provided within the machine tools.

An embodiment according to which it can be provided that the two machine tools are operated synchronously with one another is also advantageous. This provides the advantage that the first machine tool and the second machine tool can be controlled by joint control commands, which can increase the efficiency of the machining system.

According to an alternative embodiment variation it can also be provided that the two machine tools are operated in a phase-shifted manner to one another. That means that fundamentally, the same machining steps can be performed, however temporally offset to one another. This provides the advantage that deceleration energy from the recuperating operation of axes and/or spindles of the first machine tool can be applied as acceleration energy for axes and/or spindles of the second machine tool.

A symmetrical configuration of two adjacent machine tools provides the advantage that jointly used components such as a central control unit, a coolant pump, a coolant tank, a compressed air supply etc. can be configured centrally between the two machine tools.

The fact that the two machine tools are operated synchronously with one another can mean that if two structurally identical machine tools are set up next to each other they do indeed perform all displacement movements identically. The movements can thereby be occasioned by a joint, centrally arranged control unit. In a symmetrical embodiment of the two machine tools, a synchronous operation of the machine tools can means that the movements in the machine tools are performed in opposition.

According to an alternative embodiment it is of course also conceivable that the two machine tools which are arranged next to each other are not operated synchronously with one another, but rather that each of the machine tools performs machining operations independently of the other and that the two machine tools nevertheless jointly use components such as a central control unit, a coolant pump, a coolant tank, a compressed air supply etc.

A machining tool in accordance with this document can, for example, be a cutting machining tool. A machining tool in accordance with this document can, for example, also be a friction stir welding tool. In the broadest sense, a machining tool can also be understood as a measuring means or testing means accommodated in the working spindle.

For a better understanding of the invention, it is explained in more detail with reference to the following figures.

These show in significantly simplified, schematic representation:

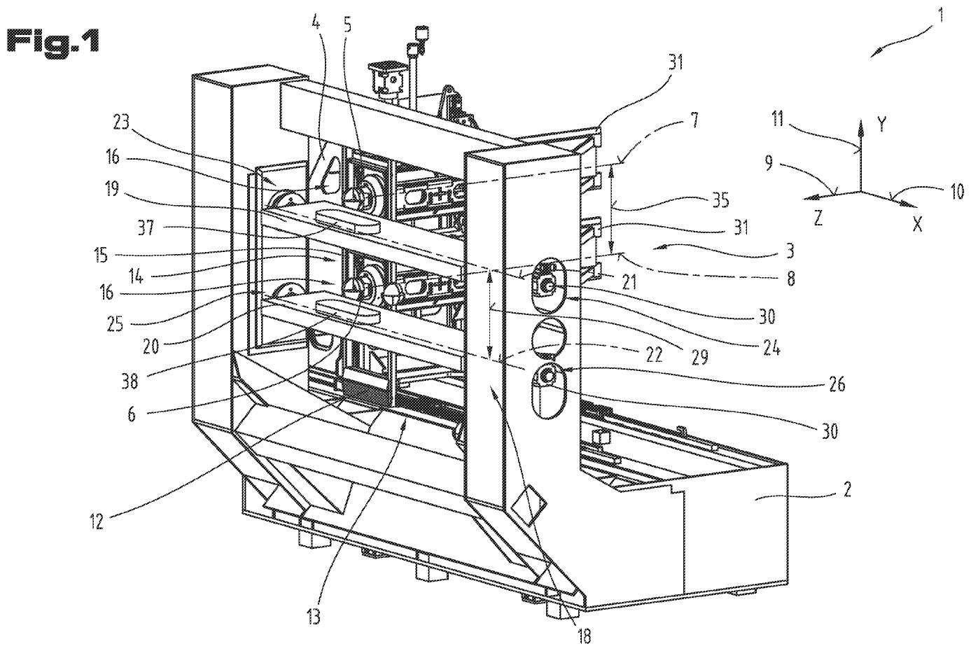

FIG. 1 a perspective view of a first example embodiment of a machine tool;

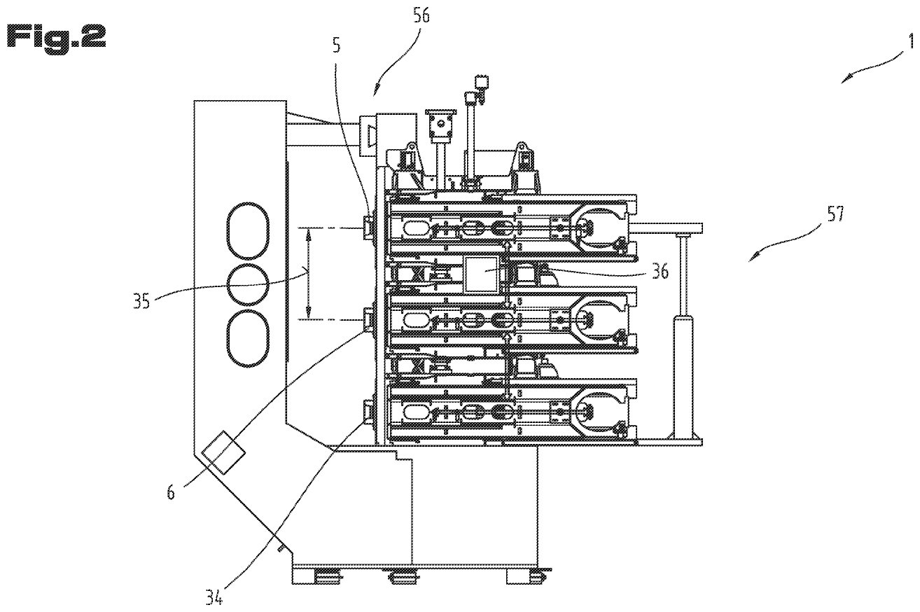

FIG. 2 a side view of a further example embodiment of the machine tool with three working spindles;

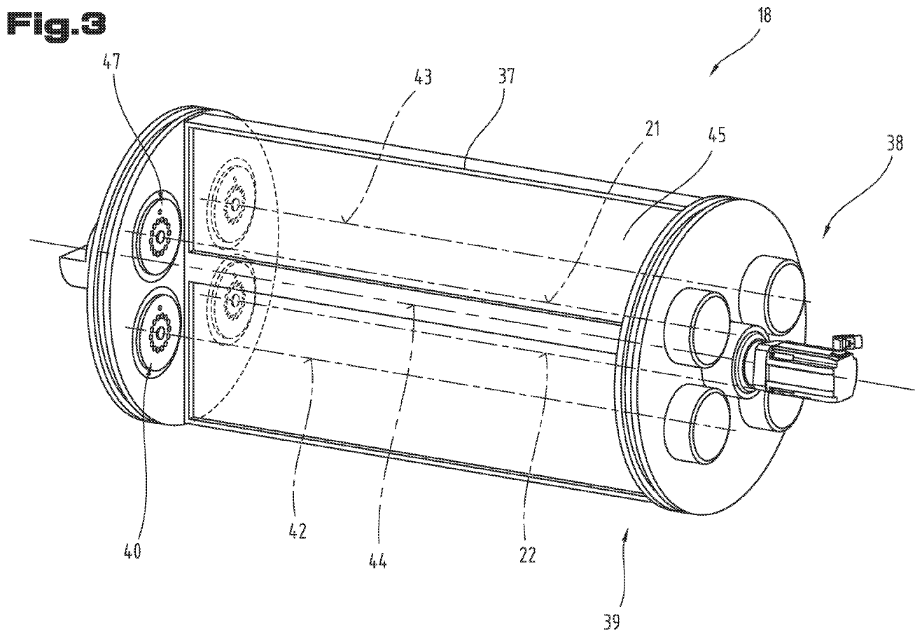

FIG. 3 a perspective view of a further example embodiment of the machine tool with a swivel bridge;

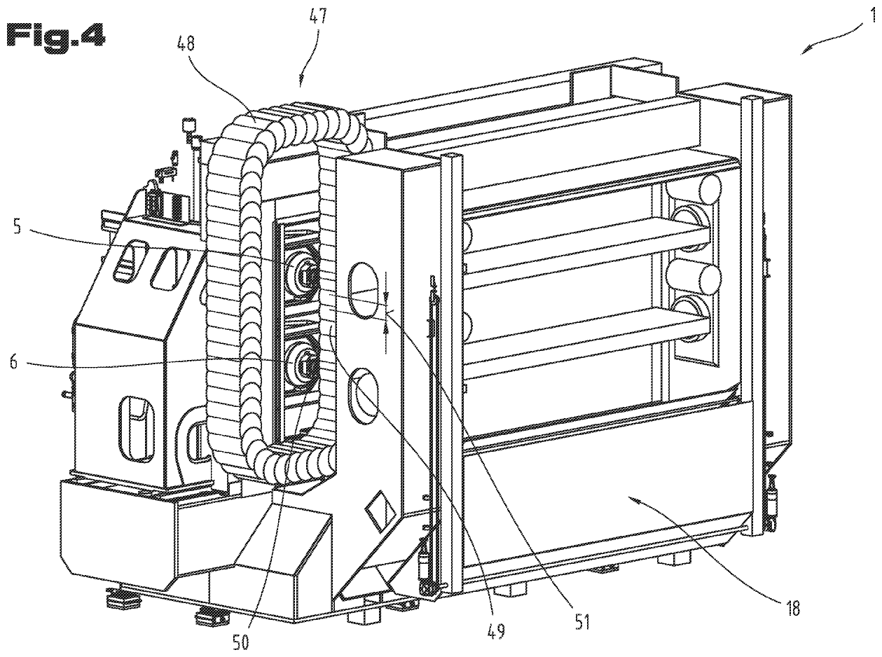

FIG. 4 a perspective view of a further example embodiment of the machine tool with a chain circulation magazine;

FIG. 5 a schematic representation of an example embodiment of a machining system with two machine tools arranged side by side;

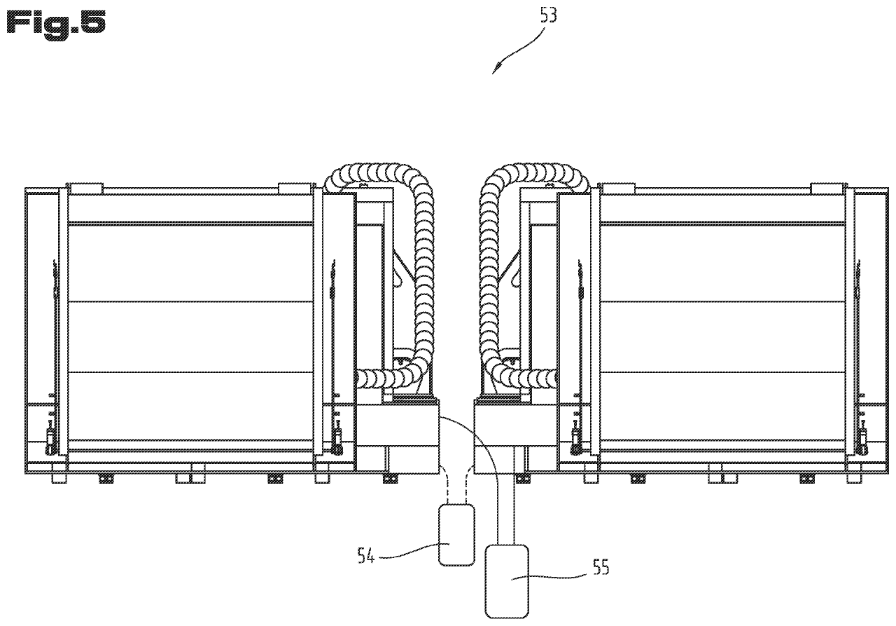

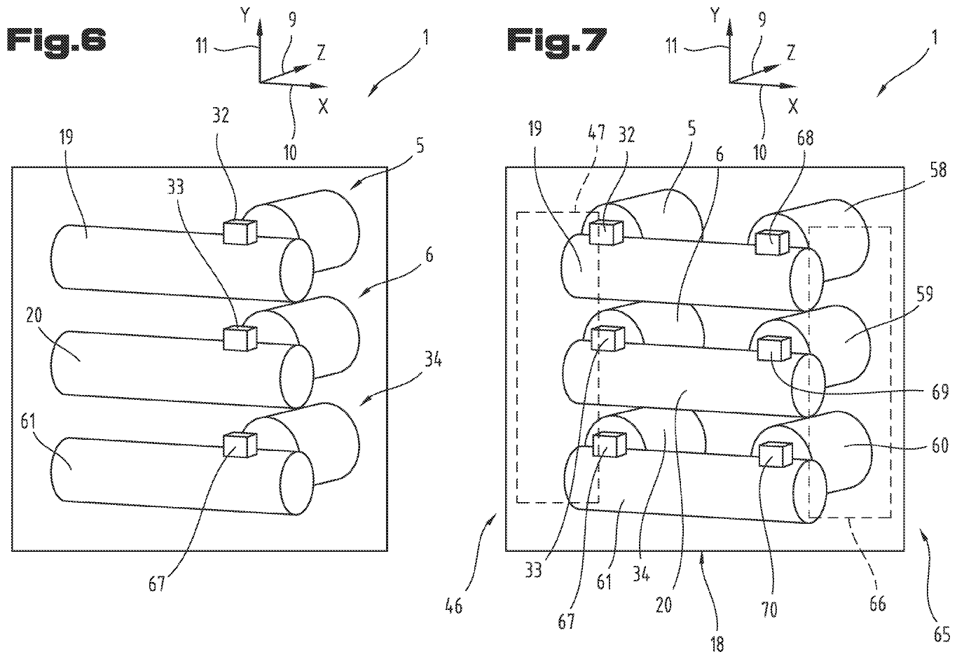

FIG. 6 a significantly simplified representation of a further example embodiment of the machine tool with three workpiece tables arranged one above the other;

FIG. 7 a significantly simplified representation of a further example embodiment of the machine tool with three workpiece tables arranged one above the other and two rows of working spindles arranged next to one another;

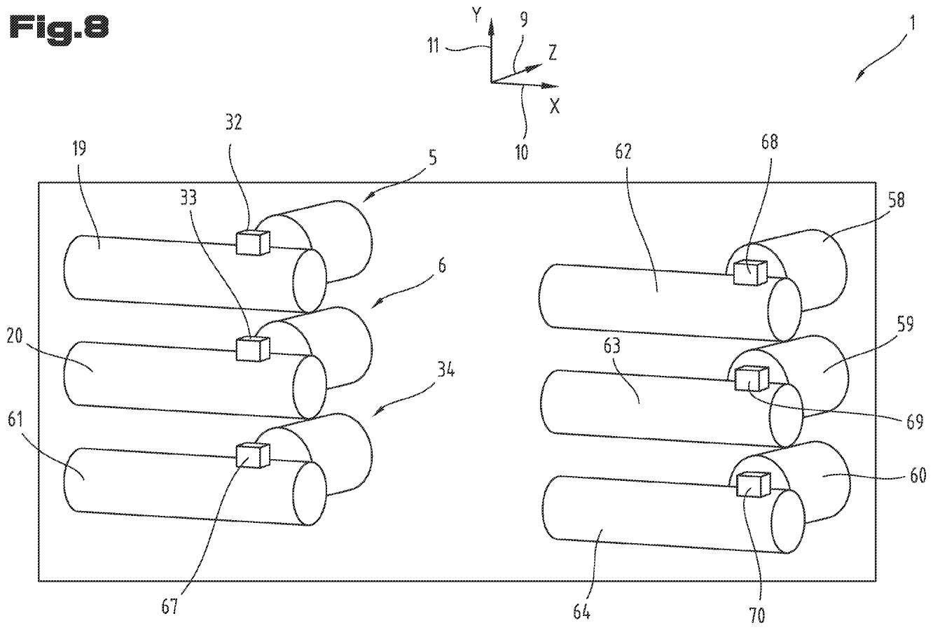

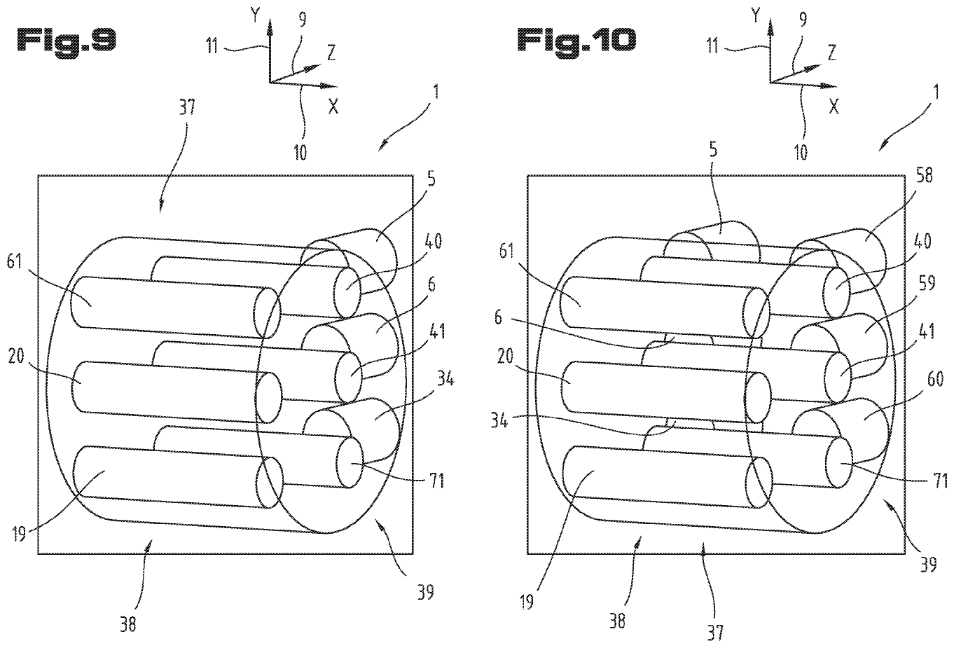

FIG. 8 a significantly simplified representation of a further example embodiment of the machine tool with three workpiece tables arranged one above the other and further workpiece tables arranged next to them, and two rows of working spindles arranged next to one another, each of which is assigned to a workpiece table;

FIG. 9 a significantly simplified representation of a further example embodiment of the machine tool with three workpiece tables arranged one above the other on a swivel drum;

FIG. 10 a significantly simplified representation of a further example embodiment of the machine tool with three workpiece tables arranged one above the other on a swivel drum and two rows of working spindles arranged next to one another;

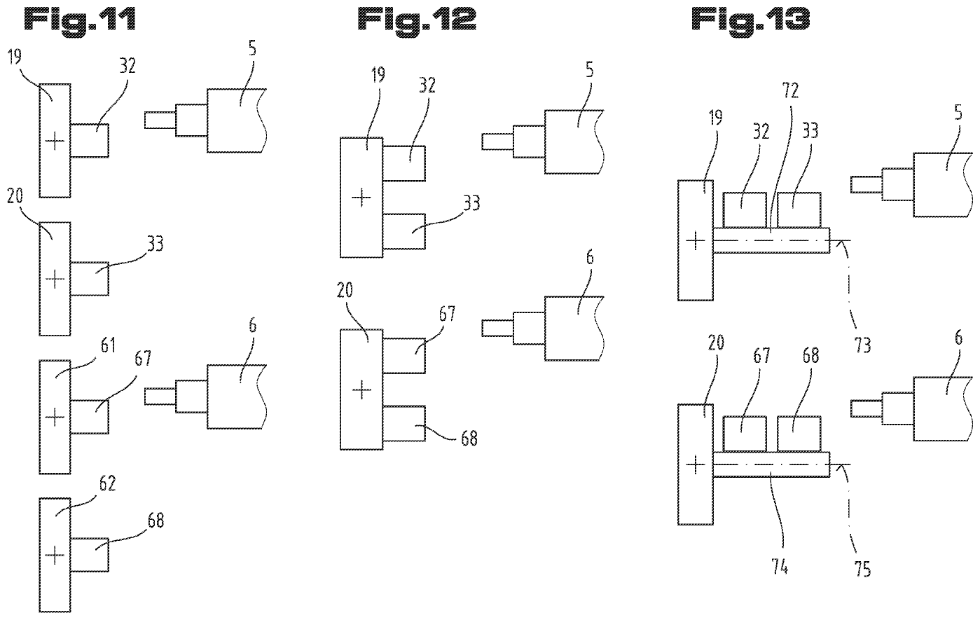

FIG. 11 a schematic side view of a further example embodiment of the machine tool with four workpiece tables arranged one above the other and two working spindles arranged one above the other;

FIG. 12 a schematic side view of a further example embodiment of the machine tool with two workpiece tables arranged one above the other and two workpieces arranged on each workpiece table;

FIG. 13 a schematic side view of a further example embodiment of the machine tool with two workpiece tables arranged one above the other and a round table arranged on each workpiece table to receive two workpieces each;

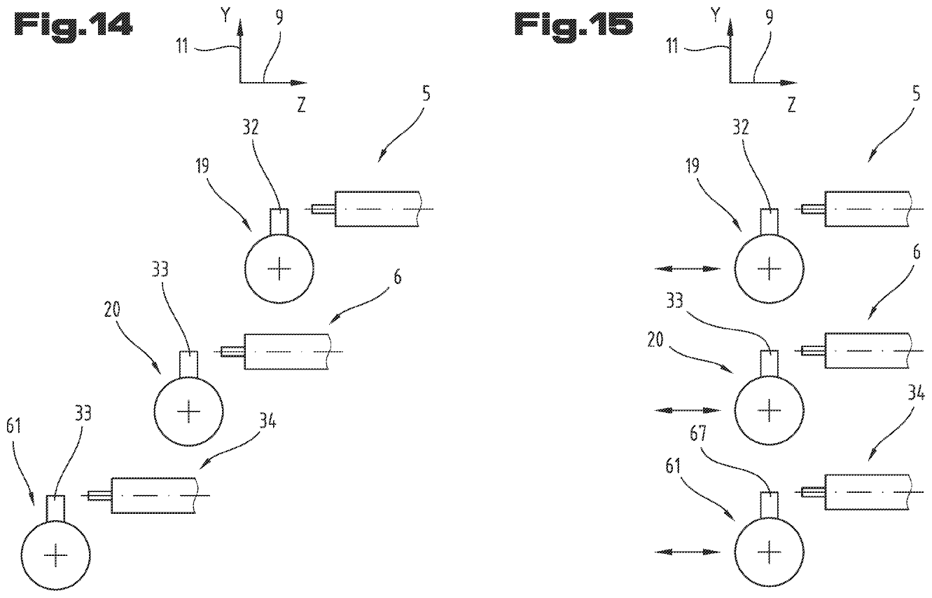

FIG. 14 a significantly simplified representation of a further example embodiment of the machine tool with three workpiece tables arranged one above the other, wherein the individual workpiece tables are arranged offset to one another;

FIG. 15 a significantly simplified representation of a further example embodiment of the machine tool with three workpiece tables arranged one above the other, wherein the individual workpiece tables are displaceable along the Z-axis.

It is worth noting here that the same parts have been given the same reference numerals or same component configurations in the embodiments described differently, yet the disclosures contained throughout the entire description can be applied analogously to the same parts with the same reference numerals or the same component configurations. The indications of position selected in the description, such as above, below, on the side etc. refer to the figure directly described and shown, and these indications of position can be applied in the same way to the new position should the position change.

FIG. 1 shows a schematic representation of a machine tool 1 for the machining of workpieces 32, 33. The machine tool 1 has a machine frame 2 which serves as the base for the components mounted on it.

The machine frame 2 is only shown schematically in FIG. 1 for the sake of clarity. It should be noted, however, that the machine frame 2 can be anchored at the installation site. Furthermore, the machine frame 2 of course serves to accommodate all components of the machine tool 1.

In addition, a spindle adjustment device 3 is configured which is arranged on or coupled to the machine frame 2. The spindle adjustment device 3 has a working head 4 on which a first working spindle 5 and a second working spindle 6 are mounted. The first working spindle 5 is mounted on the working head 4 so as to be rotatable about a first spindle axis 7 and the second working spindle 6 is mounted on the working head 4 so as to be rotatable about a second spindle axis 8. The two working spindles 5, 6 each serve to hold a machining tool and for this purpose have a clamping device for receiving the machining tool.

The working spindles 5, 6 are adjustable relative to the machine frame 2 by means of the spindle adjustment device 3 in a Z-axis 9, in an X-axis 10 and in a Y-axis 11 arranged at right angles to the Z-axis 9 and X-axis 10. In particular, it can be provided that the Z-axis 9 is arranged horizontally. The Z-axis 9 is arranged parallel to the first spindle axis 7 and to the second spindle axis 8. Furthermore, it can be provided that the X-axis 10 is also arranged horizontally. The X-axis 10 is arranged at right angles to the Z-axis 9.

The spindle adjustment device 3 has a main adjustment unit 12, which is coupled to the machine frame 2 by means of an X-axis linear guide 13. For simplified illustration, the X-axis linear guide 13 is shown only in rudimentary form. In particular, it can be provided that the X-axis linear guide 13 comprises four or more guide carriages which are coupled to the main adjustment unit 12 and which cooperate with two guide rails which are coupled to the machine frame 2.

The main adjustment unit 12 is displaceable in the direction of the X-axis 10 relative to the machine frame 2 by means of the X-axis linear guide 13.

Furthermore, it can be provided that a height adjustment unit 14 is configured which is coupled to the main adjustment unit 12 by means of a Y-axis linear guide 15. The height adjustment unit 14 is displaceable along the Y-axis 11 relative to the main adjustment unit 12 or relative to the machine frame 2 by means of the Y-axis linear guide 15.

According to a first embodiment variation shown in FIG. 1, it can be provided that the first working spindle 5 and the second working spindle 6 are each arranged on their own height adjustment unit 14 and are thus displaceable independently of each other along a Y-axis 11. In this embodiment variation, a separate drive is required for each of the height adjustment units 14.

According to a further embodiment variation shown in FIG. 2, it can be provided that the first working spindle 5 and the second working spindle 6 are each arranged on a joint height adjustment unit 14 and are thus jointly displaceable along a Y-axis 11. In this embodiment variation, only one drive is required for the joint height adjustment units 14.

The Y-axis linear guide 15 can also have a guide rail which is arranged on the main adjustment unit 12 and which is coupled to one or more guide carriages arranged on the first working spindle 5 or the second working spindle 6.

Furthermore, as can be seen in FIG. 1, it can be provided that the first working spindle 5 is displaceable on the Z-axis 9 by means of a first Z-axis linear guide 16 and that the second working spindle 6 is displaceable on the Z-axis 9 by means of a second Z-axis linear guide 16, wherein the first working spindle 5 and the second working spindle 6 are displaceable independently of each other.

In addition, the machine tool 1 includes a workpiece clamping device 18 which is used to hold the workpieces 32, 33 to be machined.

The workpiece clamping device 18 has a first workpiece table 19 and a second workpiece table 20. The first workpiece table 19 is pivotable relative to the machine frame 2 with respect to a first pivot axis 21. The second workpiece table 20 is pivotable relative to the machine frame 2 with respect to a second pivot axis 22.

The two pivot axes 21, 22 of the two workpiece tables 19, 20 are arranged parallel to the X-axis 10. In particular, it is provided that the first workpiece table 19 serves to receive the first workpiece 32 and the second workpiece table 20 serves to receive the second workpiece 33.

In particular, it can be provided that the first workpiece 32 and the second workpiece 33 have the same outer contour as each other and that the same machining steps are performed on the two workpieces 32, 33. For the sake of clarity, the two workpiece tables 19, 20 are also shown only rudimentarily in FIG. 1. Of course, a wide variety of fastening options may be provided for fastening the workpieces 32, 33 to the workpiece tables 19, 20. In particular, it can be provided that round tables are configured on each of the two workpiece tables 19, 20 which serve to fasten the workpieces 32, 33 and at the same time to rotate the workpieces 32, 33 relative to the workpiece tables 19, 20.

The first workpiece table 19 is rotatably mounted on the machine frame 2 by means of a first swivel bearing 23 and a second swivel bearing 24. Similarly, the second workpiece table 20 is rotatably mounted on the machine frame 2 by means of a first swivel bearing 25 and a second swivel bearing 26. The swivel bearings 23, 24, 25, 26 can, for example, be configured as bearing blocks which are fastened to corresponding receptacles on the workpiece table 19.

As shown in FIG. 1, it can be provided that the first workpiece table 19 has a workpiece clamping area extending between the first swivel bearing 23 and the second swivel bearing 24. Similarly, it can be provided that the second workpiece table 20 has a workpiece clamping area extending between the first swivel bearing 25 and the second swivel bearing 26 of the second workpiece table 20.

The workpiece clamping area of the first workpiece table 19 has a workpiece clamping length 27. The workpiece clamping area of the second workpiece table 20 has a workpiece clamping length 28. Preferably, it is provided that the first workpiece table 19 and the second workpiece table 20 are of the same design.

The two workpiece tables 19, 20 or the two swivel axes 21, 22 are arranged at a distance 29 from each other. The distance 29 also extends in the direction of the Y-axis 11. The embodiment described achieves that the first working spindle 5 is assigned to the first workpiece table 19 and that the second working spindle 6 is assigned to the second workpiece table 20.

In particular, it can be provided that an adjusting device is arranged in the workpiece clamping device 18, by means of which the distance 29 between the two workpiece tables 19, 20 or the two pivot axes 21, 22 can be adjusted.

By means of the machine tool 1 according to the invention, two workpieces 32, 33 which are of identical design can be machined parallel to each other. The first workpiece 32 is thereby clamped on the first workpiece table 19 and the second workpiece 33 is clamped on the second workpiece table 20. The tool of the first working spindle 5 machines the first workpiece 32 and the tool of the second working spindle 6 machines the second workpiece 33. Due to the design of the machine tool 1 according to the invention, the machining of the first workpiece 32 and the second workpiece 33 takes place synchronously. Thus, two workpieces 32, 33 can be machined simultaneously by means of a machine tool 1 of the simplest possible design, whereby the utilisation of the machine tool 1 or its productivity can be improved.

Furthermore, it can be provided that the first workpiece table 19 has a drive unit for pivoting and that the second workpiece table 20 also has a drive unit 30 for pivoting. In such an embodiment, the first workpiece table 19 and the second workpiece table 20 can be pivoted independently of each other.

In an alternative embodiment, it can be provided that the workpiece tables 19, 20 are pivoted by means of a common drive unit 30.

The drive unit 30 can be configured in the form of a torque motor, for example.

The torque motor can, for example, be coupled to the two workpiece tables 19, 20 by means of a belt drive. Alternatively, the torque motor can be coupled to the two workpiece tables 19, 20 by means of a worm gear.

In yet another alternative embodiment, it can be provided that the rotor of the torque motor is integrated directly in the workpiece tables 19, 20 and thus a separate torque motor is formed for each workpiece table 19, 20.

Furthermore, it can be provided that the two working spindles 5, 6 are driven by a common drive unit 31. The drive unit 31 can, for example, be formed by a three-phase asynchronous motor which is controlled by a frequency converter.

Furthermore, it is also conceivable that the drive unit 31 is in the form of a synchronous motor.

Of course, it can also be provided that each of the working spindles 5, 6 is driven by its own drive unit 31. In this case, it can be provided that the working spindle 5, 6 is simultaneously the rotor of the drive unit 31.

The working spindles 5, 6 of the machine tool 1 shown in FIG. 1 are displaceable with respect to the Z-axis 9, the X-axis 10 and the Y-axis 11 and are pivotable with respect to a parallel to the Y-axis. The workpieces 32, 33 received in the workpiece tables 19, 20 are pivotable with respect to a parallel to the X-axis 10. The working spindles 5, 6 thus have five degrees of freedom with respect to the adjustment relative to the workpiece 32, 33 being machined.

Furthermore, it can be provided that at least one of the working spindles 5, 6 is configured to be adjustable individually and independently of the other working spindle 5, 6 in an axial direction of the spindle axis 7, 8 of the working spindle 5, 6 relative to the working head 4. According to a further embodiment, it can be provided that both working spindles 5, 6 are configured to be adjustable in an axial direction of the spindle axis 7, 8 of the working spindle 5, 6 relative to the working head 4.

In FIG. 2, a further and possibly independent embodiment of the machine tool 1 is shown in a schematic representation, again using the same reference numerals or component designations for the same parts as in the preceding FIG. 1. To avoid unnecessary repetition, reference is made to the detailed description in the preceding FIG. 1. In particular, it should be noted that the example embodiment of said machine tool 1 as shown in FIG. 2 can have the same features or at least partially the same features as the example embodiment of the machine tool 1 as shown in FIG. 1.

As can be seen in FIG. 2, it can be provided that in addition to the first working spindle 5 and the second working spindle 6, a third working spindle 34 is configured, wherein the first working spindle 5, the second working spindle 6 and the third working spindle 34 are arranged vertically one above the other.

Irrespective of the configuration of a third working spindle 34, it can be provided that a distance 35 between the first working spindle 5 and the second working spindle 6 is adjustable in the vertical Y-axis 11 by means of a spindle distance compensation device 36.

As can further be seen in FIG. 2, it can be provided that a further X-axis linear guide 56 is configured which is arranged at a distance from the X-axis linear guide 13. In particular, it can be provided that the X-axis linear guide 13 is arranged in a lower portion of the height adjustment unit 14 and that the further X-axis linear guide 56 is arranged in an upper portion of the height adjustment unit 14. As further shown in FIG. 2, it can be provided that the further X-axis linear guide 56 is coupled to the workpiece clamping device. The measures described in this paragraph can achieve a further stabilisation of the height adjustment unit 14 and thus an improvement of the accuracy of the machine tool 1.

As indicated schematically in FIG. 2, it can be provided that a lifting support 57 is configured which acts between the main adjustment unit 12 and one of the working spindles 5, 6, 34. By means of the lifting support 57, the weight force of the working spindles 5, 6, 34 can be at least partially compensated, whereby the energy efficiency of the machine tool 1 can be improved. The lifting support 57 can, for example, be configured in the form of a pneumatic cylinder with a pressure accumulator. Furthermore, it is of course also conceivable that the lifting support 57 is configured as a counterweight, for example, which is coupled to the working spindle 5, 6, 34 by means of a traction means via a deflection. In particular, it can be provided that each of the working spindles 5, 6, 34 has its own lifting support 57.

In FIG. 3, a further and possibly independent embodiment of the machine tool 1 is shown in a schematic representation, again using the same reference numerals or component designations for the same parts as in the preceding FIGS. 1 and 2. To avoid unnecessary repetition, reference is made to the detailed description in the preceding FIGS. 1 and 2.

As shown in FIG. 3, it can be provided that the workpiece clamping device 18 has a swivel bridge 37 upon which the first workpiece table 19 and the second workpiece table 20 are arranged on a first side 38. A first rear workpiece table 40 and a second rear workpiece table 41 are configured on a second side 39 of the swivel bridge 37.

The first rear workpiece table 40 is pivoted about a first rear pivot axis 42 aligned parallel to the horizontal X-axis 10.

The second rear workpiece table 41 is pivoted about a second rear pivot axis 43 aligned parallel to the X-axis 10.

It is further provided that the swivel bridge 37 is pivoted about a swivel bridge axis 44 aligned parallel to the X-axis 10, so that depending on the swivel position of the swivel bridge 37, the first working spindle 5 is assigned to the first workpiece table 19 and the second working spindle 6 is assigned to the second workpiece table 20, or the first working spindle 5 is assigned to the first rear workpiece table 40 and the second working spindle 6 is assigned to the second rear workpiece table 41.

In other words, either the first side 38 of the swivel bridge 37 or the second side 39 of the swivel bridge 37 can be pivoted into the machining space of the machine tool 1.

As indicated schematically in FIG. 3, it can be provided that a partition wall 45 is configured between the first side 38 of the swivel bridge 37 and the second side 39 of the swivel bridge 37. The partition wall 45 can be formed as a sheet metal structure.

In particular, it can be provided that the swivel bridge 37 is accommodated in the machine tool 1 in such a way that the partition wall 45 together with an enclosure of the machine tool 1 closes off the machining area of the machine tool so that it is not accessible from the outside.

In FIG. 4, a further and possibly independent embodiment of the machine tool 1 is shown in a schematic representation, again using the same reference numerals or component designations for the same parts as in the preceding FIGS. 1 to 3. To avoid unnecessary repetition, reference is made to the detailed description in the preceding FIGS. 1 to 3.

As shown in FIG. 4, it can be provided that a tool magazine 47 is arranged at a longitudinal end 46 of the workpiece clamping device 18. The tool magazine 47 comprises a chain circulation magazine 48, wherein a straight run 49 of the chain circulation magazine 48 is aligned vertically. The first working spindle 5 and the second working spindle 6 are displaceable up to the straight run 49 of the chain circulation magazine 48. The machining tools 50 can thus be directly removed from or placed into the chain magazine 48 or placed in it by means of the first working spindle 5 or the second working spindle 6.

In particular, it can be provided that the distance 35 between the first working spindle 5 and the second working spindle 6 corresponds to a pitch 51 or a multiple of the pitch 51 of the chain circulation magazine 48. The pitch 51 denotes the distance between the individual machining tool receptacles 52 of the chain circulation magazine 48.

In FIG. 5, a further and possibly independent embodiment of the machine tool 1 is shown in a schematic representation, again using the same reference numerals or component designations for the same parts as in the preceding FIGS. 1 to 4. To avoid unnecessary repetition, reference is made to the detailed description in the preceding FIGS. 1 to 4.

As can be seen from FIG. 5, it can be provided that a machining system 53 is configured in which at least two of the machine tools 1 are set up next to each other. In particular, it can be provided that a common control technology 54 and/or a common media supply 55 is configured for both machine tools 1.

In the example embodiment example according to FIG. 5, the two machine tools 1 are symmetrical.

In FIG. 6, a further and possibly independent embodiment of the machine tool 1 is shown in a schematic representation, again using the same reference numerals or component designations for the same parts as in the preceding FIGS. 1 to 5. To avoid unnecessary repetition, reference is made to the detailed description in the preceding FIGS. 1 to 5. The machine tool 1 is shown in a significantly simplified representation in FIG. 6 for the sake of clarity.

As shown in FIG. 6, it can be provided that the machine tool 1 has the third working spindle 34 below the first working spindle 5 and the second working spindle 6. The working spindles 5, 6, 34 can be arranged one above the other. As can further be seen from FIG. 6, it can be provided that the first working spindle 5 is assigned to the first workpiece table 19 and serves for machining the first workpiece 32 received thereon. The second working spindle 6 can be assigned to the second workpiece table 20 and serve for machining the second workpiece 33 received thereon. The third working spindle 34 can be assigned to a third workpiece table 61 and serve for machining the third workpiece 67 received thereon. Alternatively, it is also conceivable that the individual working spindles 5, 6, 34 are mounted on a joint working head 4 and are jointly displaceable.

In FIG. 7, a further and possibly independent embodiment of the machine tool 1 is shown in a schematic representation, again using the same reference numerals or component designations for the same parts as in the preceding FIGS. 1 to 6. To avoid unnecessary repetition, reference is made to the detailed description in the preceding FIGS. 1 to 6.

As can be seen in FIG. 7, it can be provided that a fourth working spindle 58 is arranged next to the first working spindle 5, which can be assigned to the first workpiece table 19. Furthermore, a fifth working spindle 59 can be configured next to the second working spindle 6, which can be assigned to the second workpiece table 20. Furthermore, a sixth working spindle 60 can be configured next to the third working spindle 34, which can be assigned to the third workpiece table 61. The fourth working spindle 58 can be used for machining a fourth workpiece 68. The fifth working spindle 59 can serve for machining a fifth workpiece 69. The sixth working spindle 60 can serve for machining a sixth workpiece 70.

As can further be seen in FIG. 7, it can be provided that the tool magazine 47 is arranged at one of the longitudinal ends 46 of the workpiece clamping device 18. A further tool magazine 66 can be arranged at the second longitudinal end 65 of the workpiece clamping device 18.

In FIG. 8, a further and possibly independent embodiment of the machine tool 1 is shown in a schematic representation, again using the same reference numerals or component designations for the same parts as in the preceding FIGS. 1 to 7. To avoid unnecessary repetition, reference is made to the detailed description in the preceding FIGS. 1 to 7.

As can be seen from FIG. 8, it can be provided that the first working spindle 5 is assigned to the first workpiece table 19 and serves for machining the first workpiece 32 received thereon. The second working spindle 6 can be assigned to the second workpiece table 20 and serve for machining the second workpiece 33 received thereon. The third working spindle 34 can be assigned to a third workpiece table 61 and serve for machining the third workpiece 67 received thereon.

As can further be seen in FIG. 8, it can be provided that a fourth workpiece table 62 is formed next to the first workpiece table 19. Furthermore, it can be provided that a fifth workpiece table 63 is arranged next to the second workpiece table 20. Furthermore, it can be provided that a sixth workpiece table 64 is arranged next to the third workpiece table 61. The fourth working spindle 58 can be assigned to the fourth workpiece table 62, the fifth working spindle 59 can be assigned to the fifth workpiece table 63, and the sixth working spindle 60 can be assigned to the sixth workpiece table 64.

In particular, it can be provided that the first workpiece table 19, the second workpiece table 20, the third workpiece table 61, the fourth workpiece table 62, the fifth workpiece table 63, and the sixth workpiece table 64 are received on a common machine frame 2.

In an embodiment of the machine tool 1 as shown in FIG. 8, it can be provided that a first longitudinal end of the first workpiece 32 is received on the first workpiece table 19 and that a second longitudinal end of the first workpiece 32 is received on the fourth workpiece table 62. This measure provides the advantage that longer workpieces can be clamped on the machine tool 1. The first longitudinal end of the first workpiece 32 is thereby machined by means of the first working spindle 5 and the second longitudinal end of the first workpiece 32 is machined by means of the fourth working spindle 58. In such an embodiment, a rotary motion of the first workpiece table 19 and a rotary motion of the fourth workpiece table 62 have to be synchronised.

In particular, it is conceivable that a possible machining area of the first working spindle 5 and a possible machining area of the fourth working spindle 58 overlap to ensure that the first workpiece 32 can be machined along its full length.

Of course, the second workpiece table 20 and the fifth workpiece table 63 can likewise serve to jointly receive the second workpiece 33.

Furthermore, the third workpiece table 61 and the sixth workpiece table 64 can likewise serve to jointly receive the third workpiece 67.

In FIG. 9, a further and possibly independent embodiment of the machine tool 1 is shown in a schematic representation, again using the same reference numerals or component designations for the same parts as in the preceding FIGS. 1 to 8. To avoid unnecessary repetition, reference is made to the detailed description in the preceding FIGS. 1 to 8.

As can be seen in FIG. 9, it can be provided that the first workpiece table 19, the second workpiece table 20, and the third workpiece table 61 are arranged on the first side 38 of the swivel bridge 37. The first rear workpiece table 40, the second rear workpiece table 41 and the third rear workpiece table 71 can be arranged on the second side 39 of the swivel bridge 37.

As can further be seen in FIG. 9, it can be provided that the first working spindle 5 is assigned to the first workpiece table 19 or the first rear workpiece table 40. Furthermore, it can be provided that the second working spindle 6 is assigned to the second workpiece table 20 or the second rear workpiece table 41. Furthermore, it can be provided that the third working spindle 34 is assigned to the third workpiece table 61 or the third rear workpiece table 71.

In FIG. 10, a further and possibly independent embodiment of the machine tool 1 is shown in a schematic representation, again using the same reference numerals or component designations for the same parts as in the preceding FIGS. 1 to 9. To avoid unnecessary repetition, reference is made to the detailed description in the preceding FIGS. 1 to 9.

As can be seen in FIG. 10, it can be provided that the first workpiece table 19, the second workpiece table 20, and the third workpiece table 61 are arranged on the first side 38 of the swivel bridge 37. The first rear workpiece table 40, the second rear workpiece table 41 and the third rear workpiece table 71 can be arranged on the second side 39 of the swivel bridge 37.

As can further be seen in FIG. 10, it can be provided that the first working spindle 5 is assigned to the first workpiece table 19 or the first rear workpiece table 40. Furthermore, it can be provided that the second working spindle 6 is assigned to the second workpiece table 20 or the second rear workpiece table 41. Furthermore, it can be provided that the third working spindle 34 is assigned to the third workpiece table 61 or the third rear workpiece table 71.

As can further be seen in FIG. 10, it can be provided that a fourth working spindle 58 is arranged next to the first working spindle 5, which can be assigned to the first workpiece table 19 or the first rear workpiece table 40. Furthermore, a fifth working spindle 59 can be configured next to the second working spindle 6, which can be assigned to the second workpiece table 20 or the second rear workpiece table 41. Furthermore, a sixth working spindle 60 can be configured next to the third working spindle 34, which can be assigned to the third workpiece table 61 or the third rear workpiece table 71. The fourth working spindle 58 can be used for machining a fourth workpiece 68. The fifth working spindle 59 can serve for machining a fifth workpiece 69. The sixth working spindle 60 can serve for machining a sixth workpiece 70.

In the example embodiments according to FIGS. 6 to 10, the third working spindle 34, the third workpiece table 61, the sixth working spindle 60, the sixth workpiece table 64 or the third rear workpiece table 71 can of course also be omitted in each case so that only two working spindles or workpiece tables are arranged one above the other.

In FIG. 11, a further and possibly independent embodiment of the machine tool 1 is shown in a schematic representation, again using the same reference numerals or component designations for the same parts as in the preceding FIGS. 1 to 10. To avoid unnecessary repetition, reference is made to the detailed description in the preceding FIGS. 1 to 10.

FIG. 11 shows a side view of the machine tool.

As can be seen in FIG. 11, it can be provided that the first working spindle 5 is configured for machining a workpiece clamped on the first workpiece table 19 and, with a time offset, for machining a workpiece clamped on the second workpiece table 20.

The second working spindle 6 can be configured for machining a workpiece clamped on the third workpiece table 61 and, with a time offset, for machining a workpiece clamped on the fourth workpiece table 62. In this embodiment, it can also be provided that the individual workpiece tables are arranged one above the other.

In FIG. 12, a further and possibly independent embodiment of the machine tool 1 is shown in a schematic representation, again using the same reference numerals or component designations for the same parts as in the preceding FIGS. 1 to 11. To avoid unnecessary repetition, reference is made to the detailed description in the preceding FIGS. 1 to 11.

FIG. 12 shows a side view of the machine tool.

As can be seen in FIG. 12, it can be provided that a first workpiece 32 and a second workpiece 33 are received on the first workpiece table 19 vertically one above the other. The first working spindle 5 can serve for machining the first workpiece 32 received on the first workpiece table 19 and the second workpiece 33 received on the first workpiece table 19 in a staggered manner. The second working spindle 6 can serve for machining the third workpiece 67 received on the second workpiece table 20 and the fourth workpiece 68 received on the second workpiece table 20 in a staggered manner.

In FIG. 13, a further and possibly independent embodiment of the machine tool 1 is shown in a schematic representation, again using the same reference numerals or component designations for the same parts as in the preceding FIGS. 1 to 12. To avoid unnecessary repetition, reference is made to the detailed description in the preceding FIGS. 1 to 12.

FIG. 13 shows a side view of the machine tool.

As can be seen in FIG. 13, it can be provided that a first round table 72, which has a pivot axis 73, is received on the first workpiece table 19. The first workpiece 32 and the second workpiece 33 can be received on the first round table 72 offset in the axial direction with respect to the first pivot axis 73.

Furthermore, it can be provided that a second round table 74, which has a second pivot axis 75, is received on the second workpiece table 20. The third workpiece 67 and the fourth workpiece 68 can be received on the second round table 74 offset in the axial direction with respect to the second pivot axis 75.

Of course, it is also conceivable that several workpieces are arranged on one round table. Furthermore, it is also conceivable that several round tables are arranged one above the other.

In FIG. 14, a further and possibly independent embodiment of the machine tool 1 is shown in a schematic representation in a side view, again using the same reference numerals or component designations for the same parts as in the preceding FIGS. 1 to 13. To avoid unnecessary repetition, reference is made to the detailed description in the preceding FIGS. 1 to 13.

As can be seen in FIG. 14, it can be provided that the first workpiece table 19, in particular the uppermost workpiece table 19, is arranged offset at the greatest distance to the working head 4 in the Z-axis 9 direction. The second workpiece table 20 can be arranged at a greater distance from the working head in the Z-axis 9 direction than the first workpiece table 19. The third workpiece table 61 can be arranged at a greater distance from the working head 4 in the Z-axis 9 direction than the second workpiece table 20.

In FIG. 15, a further and possibly independent embodiment of the machine tool 1 is shown in a schematic representation in a side view, again using the same reference numerals or component designations for the same parts as in the preceding FIGS. 1 to 14. To avoid unnecessary repetition, reference is made to the detailed description in the preceding FIGS. 1 to 14.

As can be seen in FIG. 15, it can be provided that the individual workpiece tables 19, 20, 61 are displaceable in the direction of the Z-axis 9.

The example embodiments show possible embodiment variations, although it is to be noted here that the invention is not limited to the specifically represented embodiment variations of the same, but rather various combinations of the individual embodiment variations with one another are possible, and that given the technical teachings provided by the present invention this variation possibility is within the ability of the skilled person in this technical field.

The scope of protection is defined by the claims. The description and the drawings should, however, be consulted when construing the claims. Individual features or combinations of features from the various example embodiments as shown and described can constitute separate inventive solutions. The problem to be solved by the individual inventive solutions can be derived from the description.

All value ranges specified in the current description are to be understood such that they include any and all sub-ranges, e.g., the specification 1 to 10 is to be understood such that all sub-ranges, starting from the lower limit 1 and the upper limit 10 are included, i.e., all sub-ranges begin with a lower limit of 1 or more and end at an upper limit of 10 or less, e.g., 1 to 1.7, or 3.2 to 8.1, or 5.5 to 10.

As a matter of form and by way of conclusion, it is noted that, to improve understanding of the structure, elements have partially not been shown to scale and/or enlarged and/or shrunk.

List of reference numerals

| | |
|---|---|
| 1 | Machine tool |
| 2 | Machine frame |
| 3 | Common spindle adjustment device |
| 4 | Working head |
| 5 | First working spindle |
| 6 | Second working spindle |
| 7 | First spindle axis |
| 8 | Second spindle axis |
| 9 | Z-axis |
| 10 | X-axis |
| 11 | Y-axis |
| 12 | Main adjustment unit |
| 13 | X-axis linear guide |
| 14 | Height adjustment unit |
| 15 | Y-axis linear guide |
| 16 | Z-axis linear guide |
| 17 | Swivel bearing working head |
| 18 | Workpiece clamping device |
| 19 | First workpiece table |
| 20 | Second workpiece table |
| 21 | First pivot axis |
| 22 | Second pivot axis |
| 23 | First swivel bearing first workpiece table |
| 24 | Second swivel bearing first workpiece table |
| 25 | First swivel bearing second workpiece table |
| 26 | Second swivel bearing second workpiece table |
| 27 | Workpiece clamping length workpiece clamping area |
| | first workpiece table |
| 28 | Workpiece clamping length workpiece clamping area |
| | second workpiece table |
| 29 | Distance between workpiece tables |
| 30 | Drive unit workpiece tables |
| 31 | Drive unit working spindles |
| 32 | First workpiece |
| 33 | Second workpiece |
| 34 | Third working spindle |
| 35 | Distance between first working spindle and second |
| | working spindle |
| 36 | Spindle distance compensation device |
| 37 | Swivel bridge |
| 38 | First side of swivel bridge |
| 39 | Second side of swivel bridge |
| 40 | First rear workpiece table |
| 41 | Second rear workpiece table |
| 42 | First rear pivot axis |
| 43 | Second rear pivot axis |
| 44 | Swivel bridge axis |
| 45 | Partition wall |
| 46 | Longitudinal end |
| 47 | Tool magazine |
| 48 | Chain circulation magazine |
| 49 | Straight run |
| 50 | Machining tool |
| 51 | Pitch |
| 52 | Machining tool receptacle |
| 53 | Machining system |
| 54 | Control technology |
| 55 | Media supply |
| 56 | Further X-axis linear guide |
| 57 | Lifting support |
| 58 | Fourth working spindle |
| 59 | Fifth working spindle |
| 60 | Sixth working spindle |
| 61 | Third workpiece table |
| 62 | Fourth workpiece table |
| 63 | Fifth workpiece table |
| 64 | Sixth workpiece table |
| 65 | Second longitudinal end |
| 66 | Further tool magazine |
| 67 | Third workpiece |
| 68 | Fourth workpiece |
| 69 | Fifth workpiece |
| 70 | Sixth workpiece |
| 71 | Third rear workpiece table |
| 72 | First round table |
| 73 | Pivot axis first round table |
| 74 | Second round table |
| 75 | Pivot axis second round table |

1. A machine tool (1) comprising:
a machine frame (2);
at least a first working spindle (5) which is pivoted about a first spindle axis (7);
at least a second working spindle (6) which is pivoted about a second spindle axis (8);
a workpiece clamping device (18) which is configured to receive at least a first workpiece (32) and a second workpiece (33),
wherein
the first working spindle (5) and the second working spindle (6) are arranged vertically above one another.

2. The machine tool (1) according to claim 1, wherein the workpiece clamping device (18) comprises at least a first workpiece table (19) and a second workpiece table (20), wherein the first workpiece table (19) is pivoted about a first pivot axis (21) which is aligned parallel to a horizontal X-axis (10), and the second workpiece table (20) is pivoted about a second pivot axis (22) which is aligned parallel to the X-axis, and wherein the first working spindle (5) is assigned to the first workpiece table (19) and the second working spindle (6) is assigned to the second workpiece table (20), and wherein a fourth working spindle (58) is configured which is assigned to the first workpiece table (19) and wherein a fifth working spindle (59) is configured which is assigned to the second workpiece table (20), wherein the first working spindle (5) and the fourth working spindle (58) are arranged at a distance from one another in relation to the horizontal X-axis (10) and wherein the second working spindle (6) and the fifth working spindle (59) are arranged at a distance to one another in relation to the horizontal X-axis (10).

3. The machine tool (1) according to claim 2, wherein the workpiece clamping device (18) comprises at least a first rear workpiece table (40) and a second rear workpiece table (41), wherein the first rear workpiece table (40) is pivoted about a first rear pivot axis (42) which is aligned parallel to a horizontal X-axis (10), and the second rear workpiece table (41) is pivoted about a second rear pivot axis (43) which is aligned parallel to the X-axis (10), and wherein the first workpiece table (19) and the second workpiece table (20) are arranged on a first side (38) of a swivel bridge (37) which is pivoted about a swivel bridge axis (44) aligned parallel to the X-axis, and wherein the first rear workpiece table (40) and the second rear workpiece table (41) are arranged on a second side (39) of the swivel bridge (37), wherein depending on the swivel position of the swivel bridge (37)
the first working spindle (5) and the fourth working spindle (58) are assigned to the first workpiece table (19) and the second working spindle (6) and the fifth working spindle (59) are assigned to the second workpiece table (20) or
the first working spindle (5) and the fourth working spindle (58) are assigned to the first rear workpiece table (40) and the second working spindle (6) and the fifth working spindle (59) are assigned to the second rear workpiece table (41).

4. The machine tool (1) according to claim 1, wherein a fourth workpiece table (62) and a fifth workpiece table (63) are arranged on the machine frame (2), wherein the first workpiece table (19) and the fourth workpiece table (62) are arranged at a distance to one another in relation to the horizontal X-axis (10) and wherein the second workpiece table (20) and the fifth workpiece table (63) are arranged at a distance to one another in relation to the horizontal X-axis (10), wherein the first working spindle (5) is assigned to the first workpiece table (19) and wherein the second working spindle (6) is assigned to the second workpiece table (20) and wherein the fourth working spindle (58) is assigned to the fourth workpiece table (62) and wherein the fifth working spindle (59) is assigned to the fifth workpiece table (63).

5. The machine tool (1) according to claim 1, wherein a tool magazine (47) is arranged at a longitudinal end (46) of the workpiece clamping device (18), wherein the tool magazine (47) comprises a chain circulation magazine (48), wherein a straight run (49) of the chain circulation magazine (48) is aligned vertically, wherein the first working spindle (5) and the second working spindle (6) can be displaced to the straight run (49) of the chain circulation magazine (48), wherein a distance (35) between the first working spindle (5) and the second working spindle (6) corresponds to a pitch (51) or a multiple of the pitch (51) of the chain circulation magazine (48).

6. The machine tool (1) according to claim 5, wherein a further tool magazine (66) is arranged at a second longitudinal end (65) of the workpiece clamping device (18), wherein the further tool magazine (66) is configured symmetrically to the tool magazine (47).

7. A method for operating a machine tool (1) with a machine frame (2), a first working spindle (5) which is pivoted about a first spindle axis (7), at least a second working spindle (6) which is pivoted about a second spindle axis (8), and a workpiece clamping device (18) which is configured to receive at least a first workpiece (32) and a second workpiece (33), wherein
the first working spindle (5) and the second working spindle (6) are arranged vertically one above the other, comprising the method steps:
machining the first workpiece (32) using the first working spindle (5);
machining the second workpiece (33) using the second working spindle (6),
wherein
the machining of the first workpiece (32) and the machining of the second workpiece (33) is performed simultaneously.

8. The method according to claim 7, wherein a change of the machining tool (50) clamped in the first working spindle (5) and a change of the machining tool (50) clamped in the second working spindle (6) is performed simultaneously, wherein the machining tools (50) are received in a chain circulation magazine (48) with several machining tool receptacles (52), wherein those machining tools (50) arranged in those machining tool receptacles (52) which correspond to the distance (35) between the first working spindle (5) and the second working spindle (6) are configured structurally identically, wherein in a first method step the machining tool (50) clamped in the first working spindle (5) and the machining tool (50) clamped in the second working spindle (6) are each deposited in a vacant machining tool receptacle (52) of the chain circulation magazine (48) and in a second method step the chain circulation magazine (48) or the two working spindles (5, 6) are displaced so that the first working spindle (5) and the second working spindle (6) are aligned with the machining tools (50) to be newly received and wherein in a third method step the machining tools (50) to be newly received are received in the first working spindle (5) and in the second working spindle (6).

9. The method according to claim 7, wherein a fourth workpiece (68) is received on the fourth workpiece table (62) and wherein a fifth workpiece (69) is received on the fifth workpiece table (63), wherein the fourth working spindle (58) serves to machine the fourth workpiece and wherein the fifth working spindle (59) serves to machine the fifth workpiece (69), wherein the machining of the first workpiece (32), the machining of the second workpiece (33), the machining of the fourth workpiece (68) and the machining of the fifth workpiece (69) take place simultaneously.

10. The method according to claim 9, wherein the first workpiece (32), the second workpiece (33), the fourth workpiece (68) and the fifth workpiece (69) have the same configuration, wherein the machining on the first workpiece (32), on the second workpiece (33), on the fourth workpiece (68) and on the fifth workpiece (69) is performed in parallel in simultaneous method steps.
